(19) United States
(12) Patent Application Publication
(10) Pub. No.: US 2018/0040043 A1
(43) Pub. Date: Feb. 8, 2018

(54) SOCIAL ENGINEERING THROUGH GAMIFICATION

(71) Applicant: Wal-Mart Stores, Inc., Bentonville, AR (US)

(72) Inventors: Jared Kluver, Centerton, AR (US); Bradley Joseph Kieffer, Rogers, AR (US)

(21) Appl. No.: 15/655,956

(22) Filed: Jul. 21, 2017

Related U.S. Application Data
(60) Provisional application No. 62/371,521, filed on Aug. 5, 2016.

(51) Int. Cl. G06Q 30/06; A63F 13/792; G09B 3/02; G09B 5/06; G09B 9/00; G06F 3/0482

(52) U.S. Cl. CPC G06Q 30/0613; G09B 9/00; G06F 3/0482; G09B 3/02; G09B 5/065; A63F 13/792

(57) ABSTRACT

A simulation module is embedded in a popular video game which simulates the functioning and use of one or more new subsystems. The game is chosen to be one which would possibly implement one of these subsystems in the course of the game. One such new subsystem may be a mobile payment system in which a user can pay for items using his/her smartphone. The simulation module may show a simulated mobile phone and allow the user to operate the simulated smartphone to buy items within the video game, using credits accumulated while playing the video game. The user's operation of the simulation module is monitored by a monitoring module and processed by an analysis module. This may alter the difficulty level of the game or activate or deactivate various simulations of subsystems.

### RELATED APPLICATIONS

This application claims the benefit of U.S. Provisional Patent No. 62/371,521, filed Aug. 5, 2016, entitled “Social Engineering through Gamification,” the contents of which are incorporated by reference herein in their entirety.

### FIELD

Aspects of the present invention relate to a videogame system employing an embedded simulation of a new subsystem intended to be used in retail stores that allows the user to become familiar with a subsystem before having to use it in the retail store.

### BACKGROUND

It is difficult to introduce new innovative solutions that require new devices for the customer to operate that require new processes. New processes are sometimes introduced in a release to a limited number of locations typically referred to as a “Proof-of-Concept” release. This limited release minimizes costs and functions to test if users will adopt a new process/device. However, these Proof-of-Concept releases inherently encounter resistance since customers typically do not want to put in the effort to learn an unfamiliar device/process.

Even though these limited releases are less costly than a full release, they still cost the retailer due to the expenses for planning, testing, coding, and deployment involved. These costs are incurred whether or not the device/process is successful. This is a risk to the retailer since the retailer will incur costs without any guarantee that the device/process will ultimately be successful. Performing new processes in a store can cause confusion, embarrassment for being slow, and increase the likelihood the new process will not be performed.

As an example, assume that a customer attempting to use a new and unfamiliar device is at a retail checkout (point of sale) in a crowded store with multiple people at a checkout (both behind and in front of the customer). Use of the device requires the customer learning a new process. This high pressure situation could cause the customer to be unable or unwilling to “learn” the new process.

Surveys and user group studies have indicated that users are reluctant to adopt a new device that requires them to learn a new process to operate it of which they have little familiarity. Further, it is believed that a more relaxed atmosphere with little to no pressure may increase the likelihood of learning the new process/device.

“Game-Based Learning: What it is, Why it works, and Where It's Going”, by Jessica Trybus, (http://www.newmedia.org/Game-Based-Learning--What-it-is-Why-it-works-and-Where-Its-Going.html), which is also incorporated by reference as if it were set forth in its entirely herein, describes the overall goal, some advantages, and projected uses of game-based learning. It does not specifically describe its use in any areas except for a loading dock safety example. There are no other specific uses of game-based learning described in this reference, such as its use in retail sales. The software described is designed as a stand-alone system and does not relate to, or interface with current existing software or video games. As indicated above, the learning software is only effective if the users are engaged with the software, and it is interesting to them. Trying to make an interesting and instructional game is very difficult. Many different games are released each year, but only a very small percentage become popular.

“Simulation-Based Learning: Just Like the Real Thing”, Journal of Emergencies, Trauma and Shock, 210 Oct.-Dec.; 3(4) 348-352, which is also incorporated by reference as if it were set forth in its entirely herein, describes some aspects of game-based learning as applied to health care workers in a clinical setting. Again, it describes general principals and is only specific to clinical settings. Also, it appears that this software is not be related to other existing software. Again, it is doubtful that this will be interesting or popular.

Currently, there is a need for a training system for familiarizing users with new subsystems that keeps their interest to allow easy roll-out of new subsystems.

### BRIEF SUMMARY

According to aspects of the present inventive concepts there is provided a video game training system for training a user how to operate a new subsystem while playing a video game that has at least one input device adapted to receive input from the user, at least one output device adapted to provide images to the user, a memory having a pre-stored modified video game program, a processor coupled to the input device, output device and memory, adapted to run a modified video game program. The modified video game program includes an interface module functioning to receive user input through the output device, a game module functioning to drive the output device to provide images showing video game response on the output device which is a result of the user input and a simulation module that simulates the new subsystem showing at least a part of the new subsystem on the output device and allows the user to interactively provide user input to the new subsystem. The simulation module provides responses of the new subsystem through the output devices, thereby causing the user to become familiar with operation of the new subsystem.

The training system also includes a monitoring module that monitors the user's inputs against predetermined correct inputs to determine how well the user operates the new subsystem.

A reporting module provides feedback through the output device to the user on how closely the user input correlated with the predetermined correct inputs indicating how well the user operated the new system.

The new subsystem can be a mobile payment system, a self-checkout subsystem, an aisle locator subsystem, a home delivery subsystem.

The correct inputs are inputs which are considered acceptable responses by the mobile payment system in its current state.

The possible user inputs may be selecting apps on a simulated mobile phone, activating apps on the simulated mobile phone, properly positioning a simulate smartphone near a simulated mobile payment reader, typing buttons to answer questions, and typing in text.

The difficulty level may be increased by requiring the user to provide a more detailed sequence of user inputs or the number of possible inputs when interacting with the simulation of the new subsystem.

The current invention may be described as a method of training a user how to run a new subsystem comprising the steps of providing a videogame having a number of environments which the user enjoys playing, selecting at least one environment within the videogame which is consistent with using the new subsystem, embedding a simulation module that simulates the new subsystem such that it is activated when the at least one selected environment is active, and running the video game and simulation module on video game hardware.

The simulation module provides prompts through the video game hardware to the user and receives the user's responses to each prompt.

The videogame hardware monitors how effectively the user responses match correct responses and determines a score based at least partially upon how many correct responses were made by the user.

The difficulty level is increased when the user's score increases. The difficulty level is increased by requiring a longer sequence of prompts and correct responses.

The current invention may also be described as a teaching system adapted to train a user on the use of a new subsystem. The teaching system employs videogame software, a simulation module that interfaces with the video game software, that simulates the operation of the new subsystem, and video game hardware running the video game software and the simulation module which allows the user to interact with the simulation module when playing the video game software, thereby subliminally familiarizing the user with the operation of the new subsystem.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates a simplified block diagram of a portion of a novel training system according to one embodiment of the present invention.

FIG. 2 illustrates a simplified block diagram of one embodiment of the novel training system of FIG. 1 showing additional elements.

FIG. 3 illustrates a more detailed block diagram of the gaming system of FIGS. 1 and 2.

FIG. 4 illustrates a more detailed block diagram of another embodiment of the gaming system of FIGS. 1 and 2.

FIG. 5 illustrates a simplified block diagram of the novel training system of FIGS. 1 and 2 showing additional elements.

FIG. 6 is a flowchart illustrating the major steps of the functioning of one embodiment of the present invention.

### DETAILED DESCRIPTION

At least some of the following exemplary embodiments provide an improved system and method suitable for visually identifying if a product is in stock. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

Possible Solution

Retailers are constantly looking for ways to increase sales and reduce costs. Many of the new systems are introduced to help the customers. These may be electronic wallets, product finding software and apps, payment using mobile phone, etc. However, these new systems require new processes that require time for the customers to learn how to operate them.

As indicated above, the training systems must be interesting, or the customer will not use them. Therefore, the present invention will make use of existing popular video games or work in conjunction with a videogame manufacturer that will be introducing a videogame that it is expected to be popular. There usually is no problem in encouraging people to use a popular video game.

If a specific subsystem is going to be introduced, it must first be embedded into, or interact with a video game. The videogame selected must have some logical relationship to the subsystem being embedded.

Choosing a Video Game

For example, assume that a retailer wants to introduce a mobile wallet subsystem for paying for items at Point of Sale Checkout. Using this subsystem will require the customer to perform multiple new steps of selecting the tender they want to use, and providing the proper authentication. The retailer needs to know what payment tender is being presented for payment of merchandise. The retailer also needs to know the customer's identity in order to charge for the merchandise. These are many steps the customer is not accustomed to performing today and will potentially take a good deal of education to shift the way the customer currently pays for their merchandise compared to the mobile wallet.

If there was no training, and many people wanted to use the new mobile pay subsystem in an actual retail store, it would cause huge delays and long check-out lines.

Social Engineering via Gamification is the theory of retailers paying/backing game manufacturers to put processes in games that the current and upcoming users are already planning to play. This usage through gameplay and out of the actual physical store environment begins to change the behavior and expectation of the customer when they are shopping in the retailer's location and purchasing merchandise. Therefore, it was determined to embed this in a video game to allow potential customers to practice at home on the videogame before trying to use it in the retail store.

### Subject Matter Similarity

Assume that the subsystem that will be used functions to make payment. A videogame must be used which employs an environment in which the game actor will have an option to make a payment. For example, there are video games which credit the user when the user performs well in the game. These credits can be cashed out at a ‘store’ within the video game to purchase items, physical characteristics, etc.

### Viewing Perspective

It is preferred that the game include ‘first person’ views which are views from the game character's position. In this type of game, the user is actually seeing what the character sees. When the game character enters the ‘store’, processing can switch to the simulation of the subsystem. At this point views of the mobile pay equipment can be shown and the actor can make selections on his/her cell phone to start an App, make proper selections to implement payment through the smart phone.

The will be other times, when it may be more understandable if the view is of the game character, referred to as a “3^{rd} person” view, as long as there are some 1^{st} person views included.

### Control Shifts Back to Video Game

Once the payment has been completed, processing transfers back to the videogame to continue normal videogame operation, with any changes in items/characteristics purchased, and cash balance that occurred during the operation of the simulation of the subsystem.

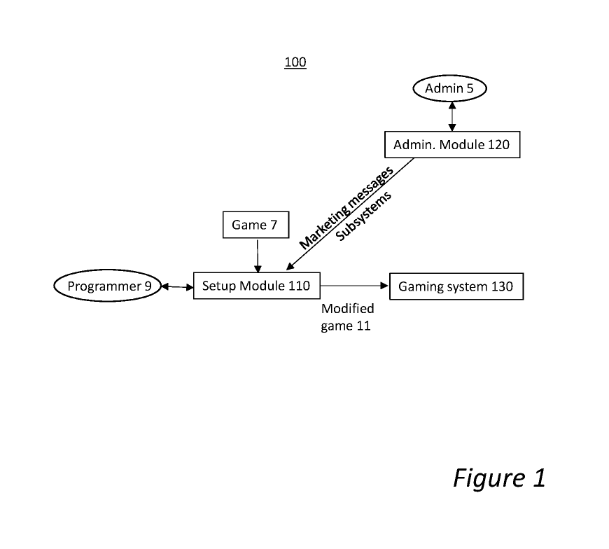

FIG. 1 illustrates a simplified block diagram of a portion of one embodiment of the novel training system 100 according to the present invention. In this embodiment, one or more subsystems are chosen by an administrator 5 using an administration module 120. Administration module 120 is internal storage in an active element that allows it to create and or store simulations of at least one subsystem, and provide the selected subsystems to a setup module 110.

A game, which may be a videogame 7 stored in non-volatile memory is also introduced to set up module 110. A programmer 9 may interact with setup module 110 to provide the appropriate patches and or custom coding to link videogame 7 to the appropriate subsystem simulation to result in a modified game 11. This modified game 11 causes a subsystem simulation to run when triggered by the proper conditions within the videogame 7.

The modified game 11 also receives marketing information from administration module 120 which is used to provide the same look and branding of how the subsystem would appear in actual implementation in a retail store.

For example, a subsystem simulation relating to mobile payment is activated when the actor in the videogame 7 chooses to buy an item. Control is then shifted from the subsystem simulation back to videogame 7 after the purchase has been completed.

Optionally, administrator 5 interacting through administration module 120 can provide marketing messages which may be merged into the game/subsystem simulation software.

Setup module 110 then loads the modified game 11 into gaming module 130. The training system 100 is now set up and ready to run.

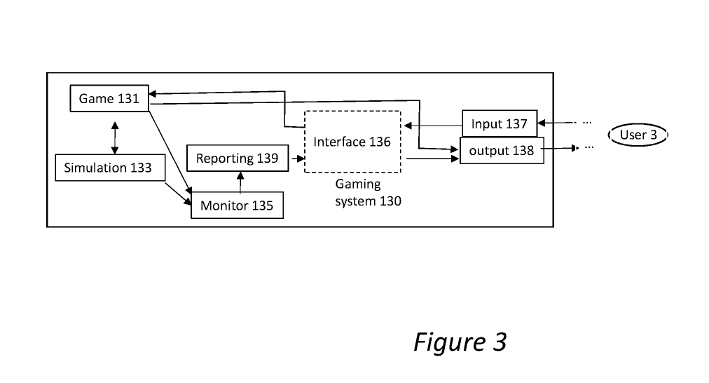

Gaming module 130 may be a conventional gaming system capable of running video game software, and has input devices (137 of FIG. 3) and output devices (138 of FIG. 3) that allow a user (3 of FIG. 3) to interact with, and “play” the game.

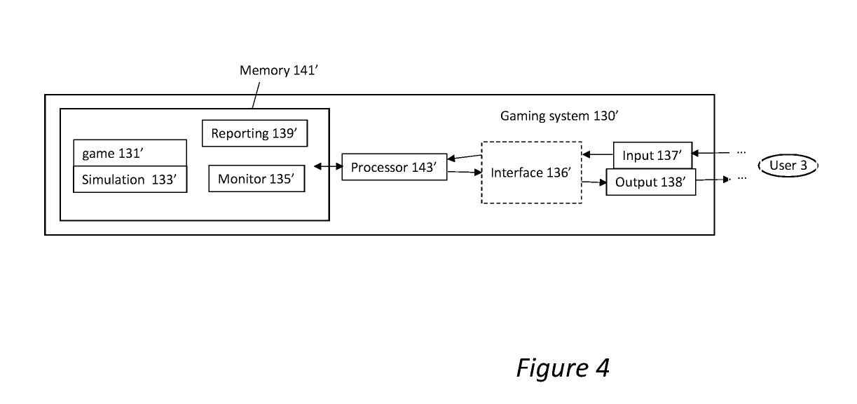

Optionally, the functionality that provides the user interface to receive input from user interact and provide output to user may be provided by a separate interface (136 of FIG. 3 and 136′ of FIG. 4).

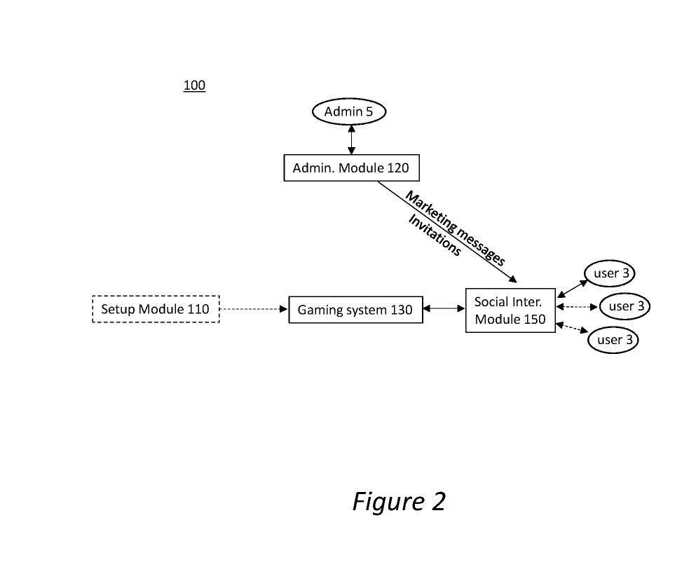

FIG. 2 illustrates a simplified block diagram of one embodiment of the training system 100 of FIG. 1 showing additional elements. In this embodiment, administrative module 120 creates invitations at least one user 3 to play the modified game 11 which are provided to social interaction module 150.

Social interaction module 150 is able to interact with multiple users 3, receive their input, and provide output back to them. Social interaction module 150 then provides an invitation to one or more of the users 3 to play the modified game 11 and gaming system 130.

Users interact with gaming system 130 through social interaction module 150 to play the modified videogame (11 of FIG. 1).

FIG. 3 illustrates a more detailed block diagram of the gaming system 130 of FIGS. 1 and 2 showing its major functional blocks. Here user 3 is shown interacting through input device 137 and output device 138 with videogame module 131. When the proper situation arises in videogame module 131 passes control to a simulation module 133. Simulation module 133 then takes over processing providing images of the subsystem on output device 138 as it is being operated by the user 3. When simulation module 135 has completed its simulation, it passes control back to videogame 131 which continues to allow user 3 to play videogame module 131.

A monitor module 135 monitors the interaction between user 3 and simulation module 133, and provides an indication of how well user 3 is operating simulation module 133. Monitor module may keep track of incorrect operations performed in certain situations to get an estimate of how well user 3 is operating the subsystem in simulation module 133.

This information is provided to a reporting module 139 which reports the information back to user 3.

FIG. 4 illustrates a more detailed block diagram of another embodiment of the gaming system 130 of FIGS. 1 and 2. In FIG. 3, each of the videogame module 131, simulation module 135, and monitor module 135 are assumed to be active elements having their own separate internal processors, memory, instructions, and means of communication. However, in the embodiment of FIG. 4, all of these functions may be performed by a single processor 143′ running executable code stored in a shared memory 141′. Here, the videogame software 131′ and the subsystem simulation routines 133′ are interconnected and stored in memory 141′. As indicated above the videogame 131′ will run until it hits the proper point in which processing control is transferred to subsystem simulation software 133′. As with the previous embodiment, input from the user 3 passes through input devices 137′ and output to the user 3 passes through output devices 138.

Again, optionally, a user interface 136′ can interact with user 3 through input device 137′ and output device 138′.

A monitor routine 135′ monitors the interaction of user 3 with subsystem simulation 133′ to identify how many incorrect actions user 3 has performed. This may be done by having a listing of acceptable actions for each state of subsystem simulation 133′. Any other actions would be considered incorrect.

Monitor program 135′ may also measure the speed in which user 3 interacts with subsystem simulation 133′.

Monitor program 135′ may periodically provide updates to user 3 of how well user 3 is performing. Monitor program 135′ may also monitor how well user 3 is interacting with game 131′. As with the previous embodiment, reporting module 139′ receives information from monitor program 135′ and creates a report of this information to user 3.

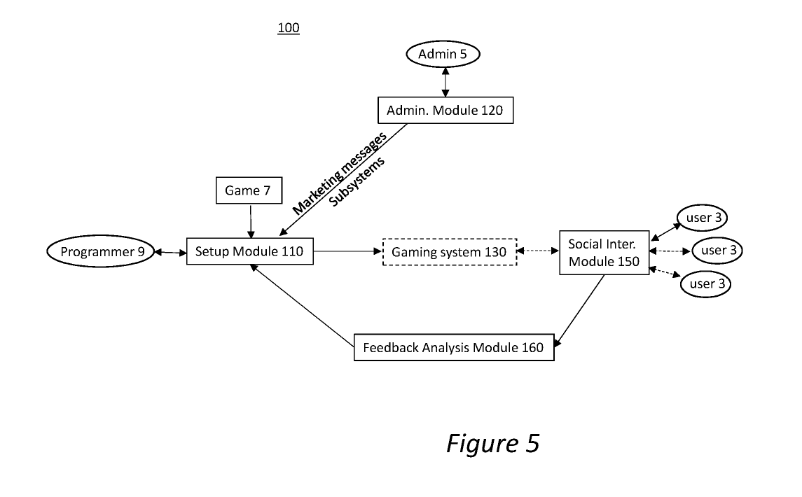

FIG. 5 illustrates a simplified block diagram of the training system of FIGS. 1 and 2 showing additional elements. Social interaction module 150 interfaces with numerous users 3. It also sees the input provided by each user to gaming system 130 and sees the output coming back from gaming system 130 to the user. Social interaction module 150 also receives the reports from reporting module 139 of FIG. 3 to indicate how well the user has mastered the subsystem simulated by simulation module 133. Therefore, social interaction module 150 can keep track of how well each user is doing in relation to the others, how well each user is operating each of the simulated subsystems, and which users require additional interaction with which subsystems.

Social interaction module 150 can provide this feedback to a feedback analysis module 160 which can determine which subsystems can be recommended to activate and deactivate.

The feedback analysis module 150 may also indicate to the users where the subsystem being simulated is in actual use, or will be in actual use in the near future. In this case the user may transition from interacting with a simulation in a game to actually operating a real system.

Administrator 5 interacts with administration module 120 to select at least one subsystem to simulate. This simulation is provided to setup module 110. The programmer 9 reconfigures game 7 to be able to pass control to at least one simulation at the proper place within game 7. With this arrangement various subsystems may be merged into game 7 depend upon the administrator's perception of which subsystem the users need to learn most.

The interactive training system may be modified to focus its training efforts upon the users that need more help by inviting them more often to play the gaming system 130. Also, the training system 100 can employ the subsystems which most of the users are not operating well.

The proposed system and method reduce the costly physical planning, testing, coding, and full deployment of a new subsystem before knowing if the subsystem will be adopted by the masses.

A video game training system is described which employs, preferably a popular video game, and embeds a simulation module. The simulation module simulates a subsystem which is going to be rolled out for use in the near future. The video game is chosen to be one which would possibly make use of a subsystem similar to the subsystem being simulated by the simulation module. If the new subsystem is a mobile (smartphone) payment system, then a game which has some type of payment may be used. In this type of game, one can embed an option of paying by mobile payment using a simulated smart phone.

### Monitoring

As the user tries to make the purchase, the user's inputs are monitored to determine how efficient the user is at operating the mobile payment system. This information may be processed for this user and game options may be changed. For example, the simulation may be more general or specific. If the user is having a hard time operating the mobile payment system, the difficulty level may be lowered to accept more general responses from the user, and to provide some hints, or explanations to walk the user though the process.

### Scoring

Similarly, if the user is doing very well, the difficulty level may be increased by requiring the user to make more detailed responses and require the user to use additional functions. The difficulty level is stored alone with information on the game and an indication of how well the user operated the simulated subsystem.

### Subsystems

The example above related to Mobile payment in a retail store. However, various other subsystems may be employed.

Another subsystem that could be linked to a video game would be an aisle locator subsystem. This is a tool which preferably implements as an App on a smartphone. The App interacts with a system of a retail store having a database of the store's inventory categorized by location in the store. This allows one to quickly find a desired product. This may be linked to a videogame which requires a person to quickly search through a retail establishment and quickly find items.

Another subsystem would be a retail Home Delivery subsystem. This is an App which is downloaded onto a smartphone. It connects with a retail computing system to allow the user to remotely buy groceries. For example, this may be linked to or embedded in a videogame in which the videogame actor cannot leave the building for some reason and therefore, must remotely order food.

It is understood that computing systems functions may be executed by one or more active devices. Therefore the functions described herein may possibly be done using different architectures and/or having different processors performing the functions described here. It is also to be understood that multiple functions may be split up into separate memories that are run a separate processors and that these functioning entities can be interconnected to accomplish the same results.

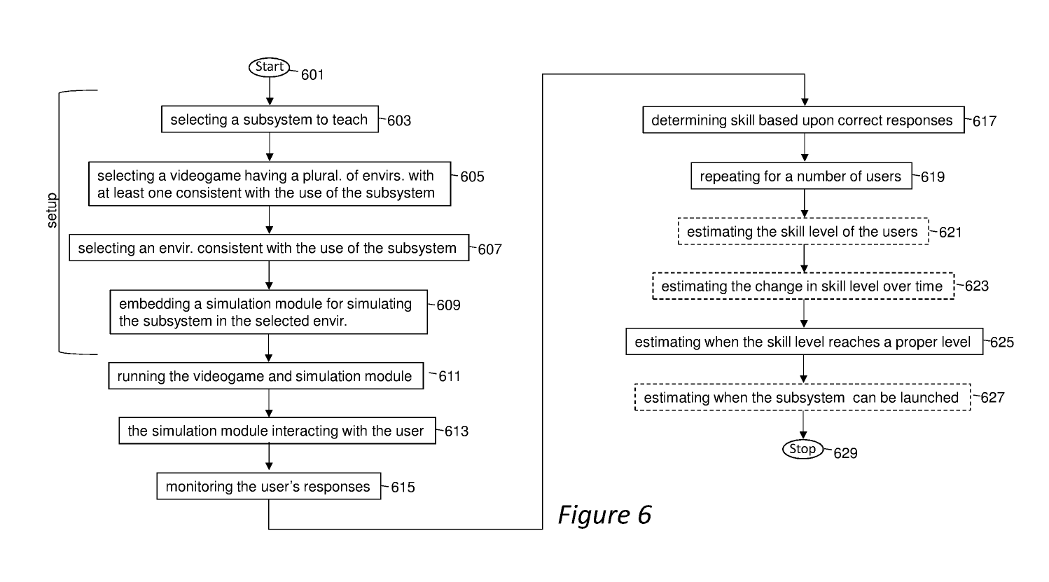

FIG. 6 is a flowchart illustrating the major steps of the functioning of one embodiment of the present invention. The process starts at step 601. In step 603 an administrator selects at least one subsystem to be tested by the current system 100.

In videogame having at least one environment which is consistent with use of the subsystem in step 605. Preferably this is a popular video game, or one that is expected to be very popular. A simulation module that simulates the subsystem is coupled to the video game program. This may be done by embedding the simulation module into the videogame and jumps to the simulation module and executes it at an appropriate time during the videogame play. Alternatively the simulation module may be separate from the videogame, but have links to and from the videogame. This may be similar to calls to a library

In still another embodiment the simulation software may be stored in a separate memory that is executed by a dedicated processor is a module. This module communicates with the remainder of the gaming system which is running the videogame. In this embodiment, the videogame module runs but at the appropriate time passes control over to the simulation module which executes its program simulating the subsystem. Once completed the simulation module passes control back to the gaming system.

Steps 603 through 609 describe the ‘set-up’ portion of the process. This configures the software system such that it may be run by a user. The administration module 120 sends invitations to the social interaction module to invite on of the users 3 to play videogame and gaming system 130.

In step 611 one of the users is running video game which includes the simulation module.

In step 613, the videogame runs and in certain environments the user is given at least one option that if selected, activates the simulation module. For example, the environment of the videogame may allow the videogame character to purchase something of value to use during the game play. In this case, the simulation module will become active and simulate one subsystem. User 3 interact with the subsystem, as it would with an actual subsystem thereby allowing user to become familiar with the work, equipment, and functioning of the subsystem, without ever having seen or experienced actual subsystem.

In step 615 uses responses are monitored, and compared to correct responses to determine how familiar the user is with the functioning of the subsystem.

In step 617 an indication of the number of correct and incorrect responses compared to the number of total responses is determined.

In an step 619, this process is repeated for a number of users

In optional step 621 an indication of a general user skill level of operating the subsystem is determined. This is based on monitoring a number of users.

In an optional step 623, the system may monitor the number of users over time and estimate the change in skill level over time. In step 625 the system may estimate when the user skill level, on the average, is a proper level for introduction of the subsystem.

In an optional step 627, the system employs the historical skill level information to extrapolate when the subsystem can be launched.

The method ends at step 629.

General Features of the System Described

1. New subsystems intended to be taught are simulated and merged into a videogame.

2. The user is more at ease and open to learning new processes/devices since when playing a game since there is no risk involved.

3. New subsystems can be introduced into actual retail stores once the public has had a chance to become familiar with the subsystems using the proposed system which employs gameplay.

Although a few examples have been shown and described, it will be appreciated by those skilled in the art that various changes and modifications might be made without departing from the scope of the invention, as defined in the appended claims.

What is claimed is:

1. A video game training system for subliminally training a user how to operate a new subsystem while playing a video game, comprising:
at least one input device adapted to receive input from the user;
at least one output device adapted to provide images to the user;
memory having a pre-stored modified video game program;
a processor coupled to the input device, output device and memory, adapted to run a modified video game program, the modified video game program comprising:
an interface module functioning to receive user input through the input device,
an operation module functioning to drive the output device to provide images showing video game response on the output device which is a result of the user input;
a simulation module that simulates the new subsystem showing at least a part of the new subsystem on the output device and allows the user to interactively provide user input to the new subsystem wherein the simulation module provides responses of the new subsystem through the output devices, thereby causing the user to become familiar with operation of the new subsystem;
a monitoring module that monitors the user's inputs against predetermined correct inputs to determine how well the user operates the new subsystem;
a reporting module which provides feedback through the output device to the user on how closely the user input correlated with the predetermined correct inputs indicating how well the user operated the new subsystem.

2. The video game training system of claim 1, wherein the new subsystem is a mobile payment system.

3. The video game training system of claim 2, wherein the predetermined correct inputs are inputs which are considered acceptable responses by the mobile payment system in its current state.

4. The video game training system of claim 3, wherein each user input may be selected from the group consisting of: selecting apps on a simulated mobile phone, activating apps on the simulated mobile phone, properly positioning a simulate smartphone near a simulated mobile payment reader, typing buttons to answer questions, and typing in text.

5. The video game training system of claim 1, wherein a difficulty level may be increased by requiring the user to provide a more detailed sequence of user inputs when interacting with the simulation of the new subsystem.

6. The video game training system of claim 4, wherein a difficulty level may be increased by increasing the number of possible inputs from which the user can choose when interacting with the simulation of the new subsystem.

7. The video game training system of claim 1, wherein the new subsystem is a self-checkout system.

8. The video game training system of claim 7, wherein the predetermined correct inputs are inputs which are considered acceptable responses by the self-checkout system in its current state.

9. The video game training system of claim 8, wherein each user input may be selected from the group consisting of: placing a simulate product with a barcode in a position and location in which it could be read by a simulated barcode reader, typing buttons on a simulated cash register screen to answer questions, and typing in text.

10. The video game training system of claim 1, wherein the new subsystem is an aisle locator subsystem which aids in locating an aisle and aisle location of a desired product in a retail store.

11. The video game training system of claim 10, wherein the predetermined correct inputs are inputs which are considered acceptable responses by the aisle locating system in its current state.

12. The video game training system of claim 11, wherein each user input may be selected from the group consisting of: selecting apps on a simulated mobile phone, activating apps on the simulated mobile phone, typing in text, reviewing and selecting images of multiple products to identify the desired product, typing buttons to answer questions, and placing a simulate product with a barcode near a simulated barcode reader.

13. The video game training system of claim 1, wherein the new subsystem is a home delivery system.

14. The video game training system of claim 13, wherein the predetermined correct inputs are inputs which are considered acceptable responses by the home delivery system in its current state.

15. The video game training system of claim 14, wherein each user input may be selected from the group consisting of: selecting apps on a simulated mobile phone, activating apps on the simulated mobile phone, typing in text, reviewing and selecting images of multiple products to identify the desired product; typing buttons to select desired products, and placing a simulate product with a barcode near a simulated barcode reader, selecting a payment method.

16. A method of training a user how to run a new subsystem comprising the steps of:
providing a video game having a plurality of environments which the user enjoys playing;
selecting at least one environment within the video game which is consistent with using the new subsystem;
embedding a simulation module that simulates the new subsystem such that it is activated when the at least one selected environment is active;
running the video game and simulation module on video game hardware;
the simulation module providing prompts through the video game hardware to the user and receiving the user responses to each prompt;
monitoring with video game hardware how effectively the user responses match correct responses;
the simulation module determining with video game hardware a skill indication based at least partially upon how many correct responses were made by the user.

17. The method of claim 16 wherein a difficulty level is increased when the user's score increases.

18. A teaching system adapted to train a user on the use of a new subsystem, comprising:
video game software;
a simulation module that interfaces with the video game software, that simulates the operation of the new subsystem; and
video game hardware running the video game software and the simulation module which allows the user to interact with the simulation module when playing the video game software, thereby subliminally familiarizing the user with the operation of the new subsystem.

19. The teaching subsystem of claim 18 wherein the interaction between the user and the simulation module comprises:
the simulation module being adapted to:
prompt the user to provide input;
receive user input being one of a plurality of possible inputs to the simulation module;
move to a next step if the user input is acceptable to the simulation module;
repeat the step if the input provided is not acceptable;
process additional steps simulating the functioning of the subsystem until a final step is encountered; and
returning processing to the video game software.

20. The teaching system of claim 18, further comprising:
a monitoring module which keeps track of how many times the user correctly interacts with the simulation module and provides an indication of a skill level based upon the number of correct interactions.
